(19) United States
(12) Patent Application Publication
(10) Pub. No.: US 2008/0201941 A1
(43) Pub. Date: Aug. 28, 2008

(54) Multistage Compression Tool For Coaxial Cable Connector

(76) Inventor: Noah Montena, Syracuse, NY (US)

Correspondence Address: PASTEL LAW FIRM, 8 PERRY LANE, ITHACA, NY, 14850, US

(21) Appl. No.: 11/677,600

(22) Filed: Feb. 22, 2007

(51) Int. Cl. B23P 19/027

(52) U.S. Cl. 29/751; 29/434; 29/749; 29/758

(57) ABSTRACT

A multistage compression tool for attaching a coaxial cable connector to a coaxial cable includes a sliding bolt which moves in response to a lever arm. The sliding bolt includes a plunger and a sliding ring attached to a spring. First stage compression is complete when the sliding ring stops moving forward. Second stage compression begins as the compression force on the spring causes the plunger to move forward and ends when the lever arm is fully closed. The first stage of compression seizes an outer conductor of the coaxial cable connector, while the second stage of compression seizes an inner conductor of the coaxial cable connector.

### FIELD OF THE INVENTION

This invention relates generally to the field of coaxial cable connectors, and more particularly, to a tool for attaching a coaxial cable connector to an end of a coaxial cable.

### BACKGROUND OF THE INVENTION

Coaxial cable is installed on a widespread basis in order to carry signals for communications networks such as cable television (CATV) and computer networks. The coaxial cable must at some point be connected to network equipment ports. In general, it has proven difficult to make such connections without requiring labor intensive effort by highly skilled technicians.

These generalized installation problems are also encountered with respect to spiral corrugated coaxial cable, sometimes known as “Superflex” cable. Spiral corrugated coaxial cable is a special type of coaxial cable that is used in situations where it is necessary for the cable to be rotation resistant and/or highly flexible. Unlike standard coaxial cable, spiral corrugated coaxial cable has an irregular outer surface, which makes it difficult to design connectors or connection techniques in a manner that provides a high degree of mechanical stability, electrical shielding, and environmental sealing, but which does not physically damage the irregular outer surface of the cable.

When affixing a cable connector to a coaxial cable, it is necessary to provide good electrical and physical contact between the cable connector and the center conductor and metal corrugated sheath of the cable. It is also desirable to connect the metal corrugated sheath and the center conductor without having to reposition the cable connector within a connecting tool during the connection operation.

### SUMMARY OF THE INVENTION

Briefly stated, a multistage compression tool for attaching a coaxial cable connector to a coaxial cable includes a sliding bolt which moves in response to a lever arm. The sliding bolt includes a plunger and a sliding ring attached to a spring. First stage compression is complete when the sliding ring stops moving forward. Second stage compression begins as the compression force on the spring causes the plunger to move forward and ends when the lever arm is fully closed. The first stage of compression seizes an outer conductor of the coaxial cable connector, while the second stage of compression seizes an inner conductor of the coaxial cable connector.

According to an embodiment of the invention, a multistage compression tool for use with a compression connector, the compression connector including first seizure means for seizing an outer conductor of a coaxial cable and second seizure means for seizing a center conductor of the coaxial cable, includes a main body; a sliding bolt slidably movable within the main body and in an axial direction of the main body; a lever arm pivotally connected to the main body; a connecting link pivotally connected between the lever arm and the sliding bolt; the sliding bolt including a plunger; the sliding bolt further including a sliding ring connected to a main part of the sliding bolt via a spring; and wherein the multistage compression tool operates in first and second stages; and wherein, when the multistage compression tool is used to connect the compression connector to the coaxial cable, the first stage causes the first seizure means to seize the outer conductor of the coaxial cable, and the second stage causes the second seizure means to seize the center conductor of the coaxial cable.

According to an embodiment of the invention, a method for making a multistage compression tool for use with a compression connector, wherein the compression connector includes first seizure means for seizing an outer conductor of a coaxial cable and second seizure means for seizing a center conductor of the coaxial cable, includes the steps of: (a) forming a main body; (b) forming a sliding bolt; the sliding bolt including a plunger and a sliding ring connected to a main part of the sliding bolt via a spring; (c) inserting the sliding bolt within the main body such that the sliding bolt is slidably movable in an axial direction of the main body; (d) pivotally connecting a lever arm to the main body; and (e) pivotally connecting a connecting link between the lever arm and the sliding bolt; wherein the multistage compression tool operates in first and second stages; and wherein, when the multistage compression tool is used to connect the compression connector to the coaxial cable, the first stage causes the first seizure means to seize the outer conductor of the coaxial cable, and the second stage causes the second seizure means to seize the center conductor of the coaxial cable.

### BRIEF DESCRIPTION OF THE DRAWINGS

FIG. 1 shows a perspective view of a multistage compression tool according to an embodiment of the invention, with the tool in a closed position.

FIG. 2 shows a perspective view of the embodiment of FIG. 1, with the tool in an open position.

FIG. 3 shows a partial cutaway perspective view of the embodiment of FIG. 1, with the tool in the open position.

FIG. 4 shows a partial cutaway perspective view of the embodiment of FIG. 1, with the tool in the closed position after the first stage of the compression operation.

FIG. 5 shows a partial cutaway perspective view of the embodiment of FIG. 1, with the tool in the closed position after the second stage of the compression operation.

FIG. 6 shows a partial cutaway side elevation view of a compression connector used with the multistage compression tool of the present invention.

FIG. 7 shows a partial cutaway side elevation view of a compression connector used with the multistage compression tool of the present invention, after the first stage of compression operation.

FIG. 8 shows a partial cutaway side elevation view of a compression connector used with the multistage compression tool of the present invention, after the second stage of compression operation.

### DETAILED DESCRIPTION OF THE PREFERRED EMBODIMENT

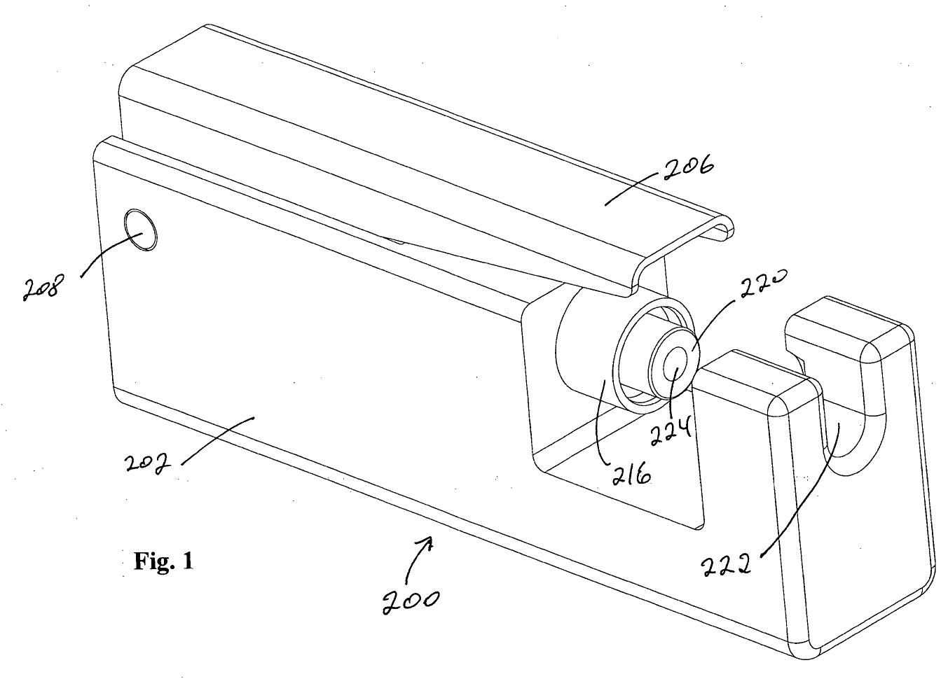

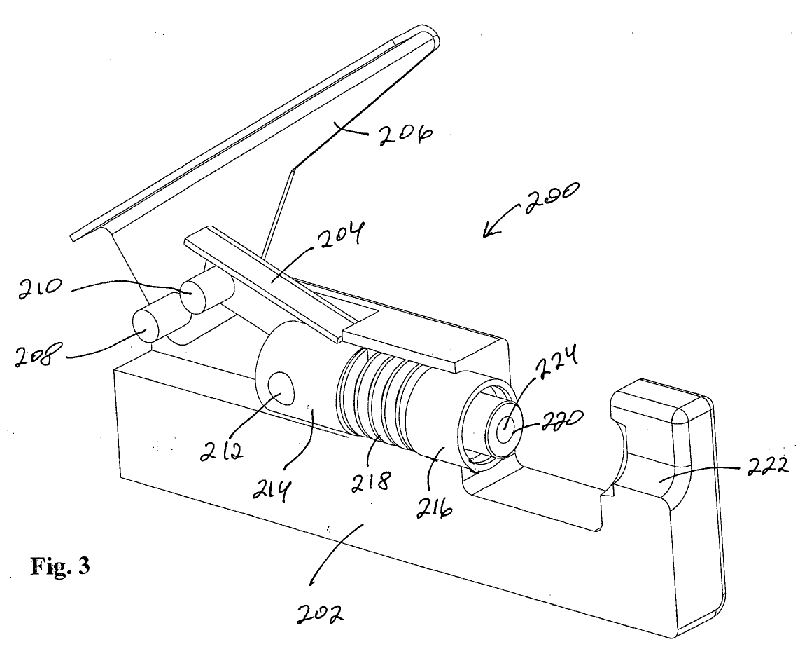

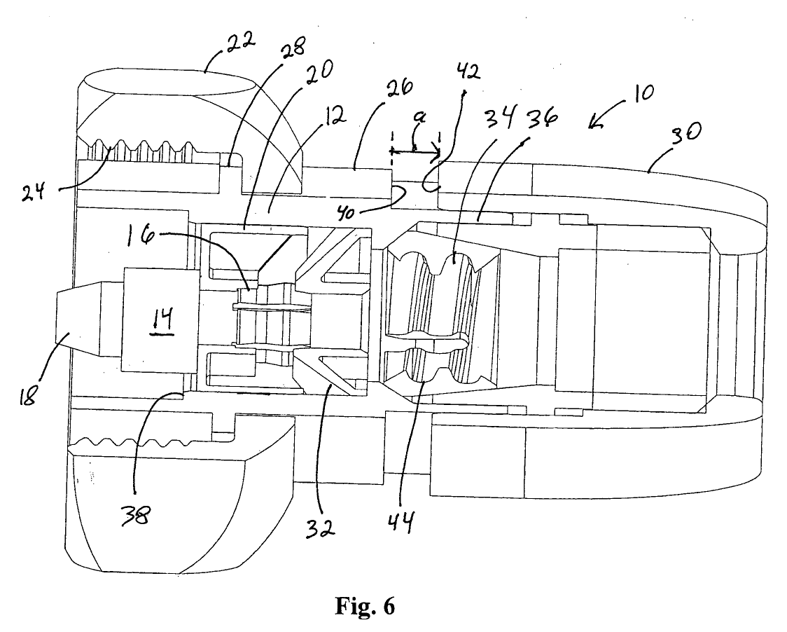

Referring to FIGS. 1-3, a multistage compression tool 200 is shown which includes a main body 202 and a lever arm 206 pivotally connected to main body 202 via a pivot pin 208. As best seen in FIG. 3, lever arm 206 is pivotally connected to a connecting link 204 via a pivot pin 210, while connecting link 204 is pivotally connected to a sliding bolt 214 via a pivot pin 212. Sliding bolt 214 includes a sliding ring 216 which is connected to a stiff spring 218, such as a die spring. Sliding bolt 214 further includes a plunger 220 which plunger 220 preferably includes a recess 224. A holding slot 222 helps hold a compression connector 10 (FIGS. 6-8) during a compression operation, during which operation compression connector 10 is electrically and physically attached to a center conductor (not shown) and an outer conductor 44 of a spiral corrugated coaxial cable 34, as is described later.

Referring to FIG. 6, a compression connector 10 is shown which is designed to be used with multistage compression tool 200. Although this figure shows a DIN male connector, other connector interfaces can include a BNC connector, a TNC connector, an F-type connector, an RCA-type connector, a DIN female connector, an N male connector, an N female connector, an SMA male connector, and an SMA female connector. Compression connectors designed to be used with multistage compression tool 200 include the ones shown and described in U.S. patent application Ser. No. ______ (Attorney Docket No. 205_{—}211) filed on Feb. 22, 2007 and entitled A COMPACT COMPRESSION CONNECTOR FOR ANGULAR CORRUGATED COAXIAL CABLE and U.S. patent application Ser. No. ______ (Attorney Docket No. 205_{—}215) filed on) Feb. 22, 2007 and entitled COAXIAL CABLE CONNECTOR WITH INDEPENDENTLY ACTUATED ENGAGEMENT OF INNER AND OUTER CONDUCTORS, both of which are incorporated herein by reference.

Compression connector 10 includes a body 12 to which a nut 22 is operatively associated. Nut 24 preferably includes a thread 24 which screws onto a corresponding thread (not shown) on a terminal port (not shown) or equipment (not shown). Nut 22 is retained on body 12 between a nut retaining ring 26 and an annular ridge 28. Annular ridge 28 is preferably one-piece with body 12. A collet pin 14 is held centered in place within body 12 by an insulator 20, which is of plastic and preferably contains air spaces for impedance matching. Collet pin 14 includes a pin portion 18 and a collet portion 16. A compression sleeve 30 slidably fits over a portion 36 of body 12.

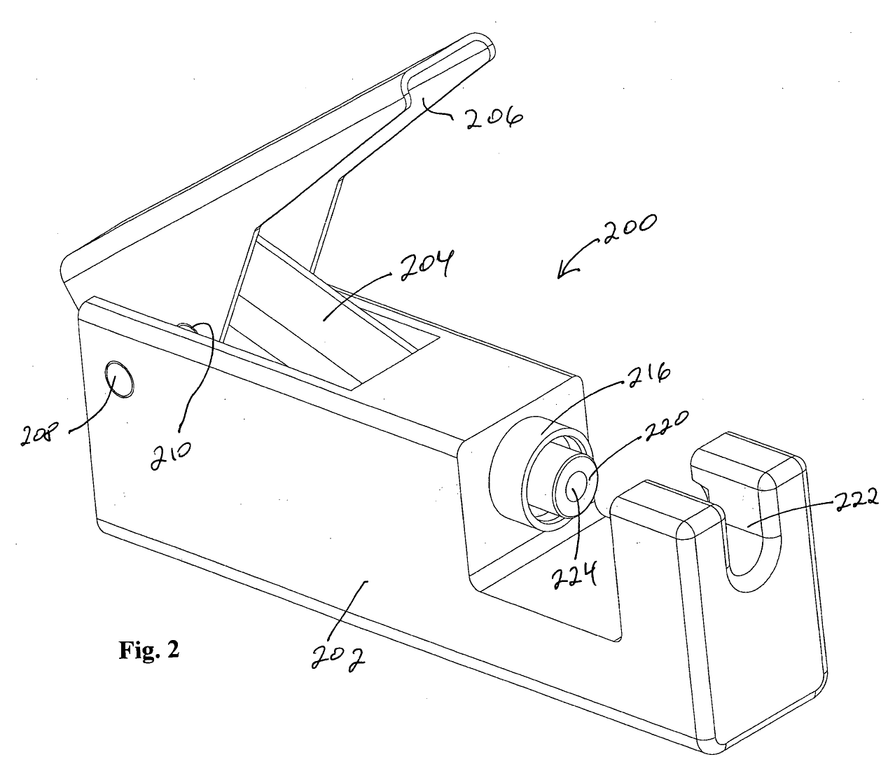

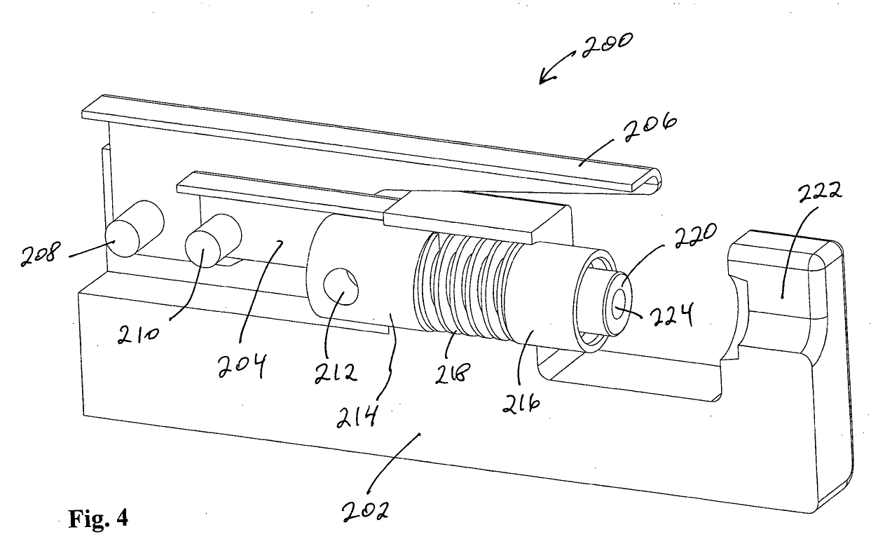

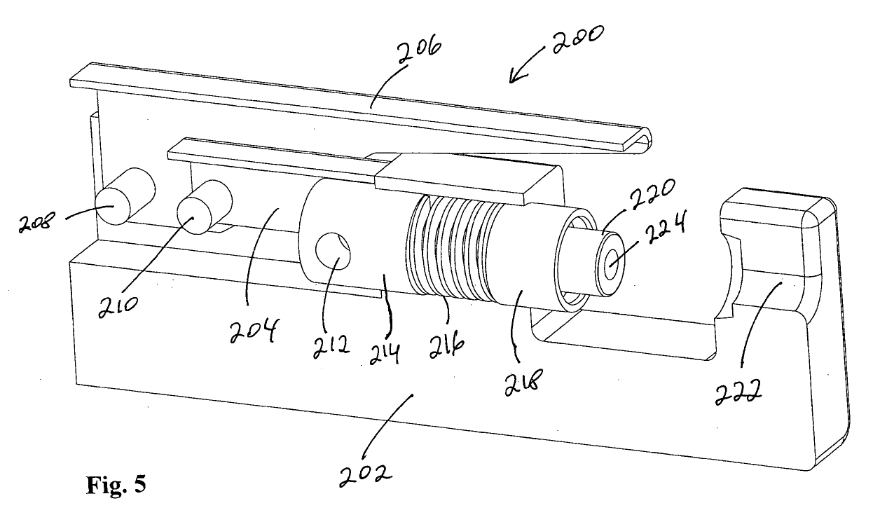

When connecting compression connector 10 to a cable 34 using multistage compression tool 200 (FIGS. 1-5), pin portion 18 fits into recess 224 of tool 200 while sleeve 30 is secured in holding slot 222. Lever arm 206 is raised at this time, as shown in FIGS. 2 and 3. As lever arm 206 is lowered towards the position as shown in FIGS. 1, 4, and 5, sliding bolt 214 is moved forward by connecting link 204, with the result that sliding ring 216 pushes against a shoulder 38 of body 12 until a shoulder 40 of body 12 abuts a shoulder 42 of sleeve 30 as shown by arrow a in FIG. 6. Moving compression sleeve 30 over body 12 completes the seizure of outer conductor 44. This action completes the first stage of compression.

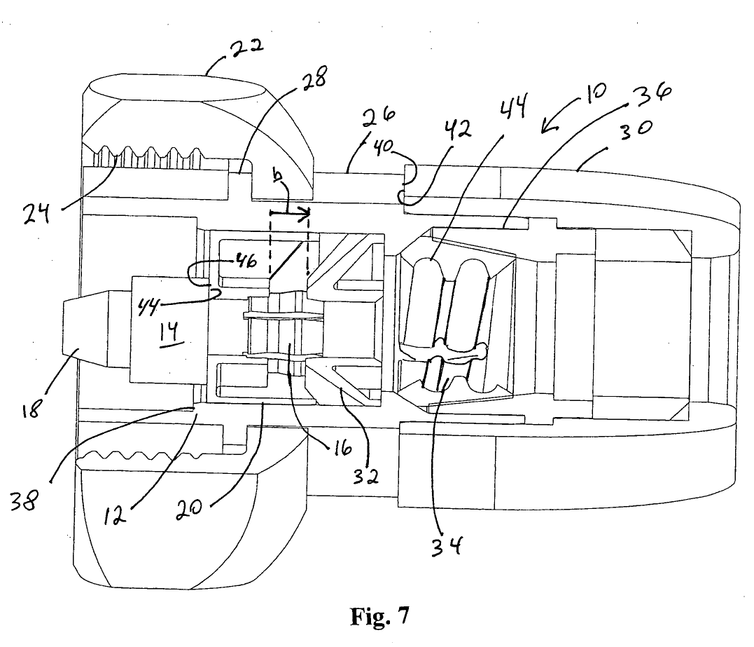

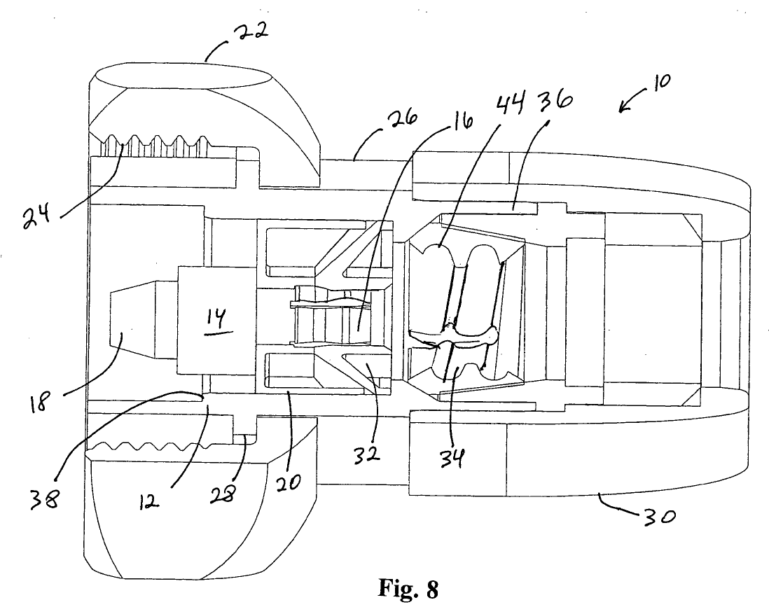

FIG. 7 shows the relative positions of body 12 and sleeve 30 after the first stage of compression. The second stage of compression begins to occur once shoulder 40 of body 12 abuts shoulder 42 of sleeve 30 and sliding ring 216 stops moving. The additional movement of lever arm 206 to the final position shown in FIGS. 1, 4, and 5 causes spring 218 to compress, thus forcing plunger 220 to continue pressing against pin portion 18 of collet pin 14. Because a shoulder 44 of collet pin 14 is in contact with a shoulder 46 of insulator 20, the force from plunger 220 moves insulator 20 against a seizure bushing 32 as shown by arrow b in FIG. 7, thus firmly seating a center conductor (not shown) of coaxial cable 34 in collet portion 16. Seizure bushing 32 preferably has a diameter slightly smaller than a diameter of collet portion 16. This action completes the second stage of compression, with connector 10 appearing as shown in FIG. 8. The timing of the seizure of outer conductor 44 (first stage of compression) being after the seizure of the central conductor (second stage of compression) is important so that the center conductor is nor buckled or damaged.

The foregoing description of the features and operation of multistage compression tool 200 is with respect to the embodiment of compression connector 10. Depending on the type and particular design of other embodiments of the compression connector used, different surfaces of the compression connector may be affected by the operation of sliding ring 216 and plunger 220. In addition, the exact shapes of sliding ring 216 and plunger 220 are specific to each type of connector and are optionally varied to suit the type of connector that tool 200 is used With.

While the present invention has been described with reference to a particular preferred embodiment and the accompanying drawings, it will be understood by those skilled in the art that the invention is not limited to the preferred embodiment and that various modifications and the like could be made thereto without departing from the scope of the invention as defined in the following claims.

What is claimed is:

1. A multistage compression tool for use with a compression connector, the compression connector including first seizure means for seizing an outer conductor of a coaxial cable and second seizure means for seizing a center conductor of the coaxial cable, comprising:
a main body;
a sliding bolt slidably movable within the main body and in an axial direction of the main body;
a lever arm pivotally connected to the main body;
a connecting link pivotally connected between the lever arm and the sliding bolt;
the sliding bolt including a plunger;
the sliding bolt further including a sliding ring connected to a main part of the sliding bolt via a spring; and
wherein the multistage compression tool operates in first and second stages; and wherein, when the multistage compression tool is used to connect the compression connector to the coaxial cable, the first stage causes the first seizure means to seize the outer conductor of the coaxial cable, and the second stage causes the second seizure means to seize the center conductor of the coaxial cable.

2. A multistage compression tool according to claim 1, further comprising a recess in an end of the plunger.

3. A multistage compression tool according to claim 1, further comprising a holding slot in the main body which holds the compression connector.

4. A multistage compression tool according to claim 1, wherein a shape of an end of the sliding ring corresponds a shape of a portion of the compression connector against which the end of the sliding ring makes contact when the multistage compression tool operates in the first and second stages.

5. A multistage compression tool according to claim 1, wherein a shape of an end of the plunger corresponds a shape of a portion of the compression connector against which the end of the plunger makes contact when the multistage compression tool operates in the first and second stages.

6. A method for making a multistage compression tool for use with a compression connector, wherein the compression connector includes first seizure means for seizing an outer conductor of a coaxial cable and second seizure means for seizing a center conductor of the coaxial cable, comprising the steps of:
forming a main body;
forming a sliding bolt; the sliding bolt including a plunger and a sliding ring connected to a main part of the sliding bolt via a spring;
inserting the sliding bolt within the main body such that the sliding bolt is slidably movable in an axial direction of the main body;
pivotally connecting a lever arm to the main body; and
pivotally connecting a connecting link between the lever arm and the sliding bolt;
wherein the multistage compression tool operates in first and second stages; and
wherein, when the multistage compression tool is used to connect the compression connector to the coaxial cable, the first stage causes the first seizure means to seize the outer conductor of the coaxial cable, and the second stage causes the second seizure means to seize the center conductor of the coaxial cable.

7. A method according to claim 6, further comprising the step of forming a recess in an end of the plunger.

8. A method according to claim 6, further comprising the step of forming a holding slot in the main body which holds the compression connector.

9. A method according to claim 6, further comprising the step of forming a shape of an end of the sliding ring to correspond with a shape of a portion of the compression connector against which the end of the sliding ring makes contact when the multistage compression tool operates in the first and second stages.

10. A method according to claim 6, further comprising the step of forming a shape of an end of the plunger to correspond with a shape of a portion of the compression connector against which the end of the plunger makes contact when the multistage compression tool operates in the first and second stages.
